(19) United States
(12) Patent Application Publication
(10) Pub. No.: US 2005/0175009 A1
(43) Pub. Date: Aug. 11, 2005

(54) Enhanced multicast forwarding cache (eMFC)

(76) Inventor: Fred Bauer, Burlingame, CA (US)

Correspondence Address: MARGER JOHNSON & MCCOLLOM, P.C., 1030 SW MORRISON STREET, PORTLAND, OR, 97205, US

(21) Appl. No.: 11/054,034

(22) Filed: Feb. 8, 2005

Related U.S. Application Data
(60) Provisional application No. 60/543,353, filed on Feb. 9, 2004.

(51) Int. Cl. H04L 12/28

(52) U.S. Cl. 370/390

(57) ABSTRACT

An Enhanced Multicast Forwarding Cache (eMFC) supports multicast transmissions in mobile mesh networks. The enhanced MFC is designed to support mesh node mobility, quality of service, and security requirements that are particular to mesh networks. To achieve these goals, the enhanced MFC draws from a global state maintained by a unicast routing protocol, multicast aware applications, and distributed services. The eMFC distributes this derived global state through the use of an eMFC-specific multicast packet header. Information contained within the eMFC header is also used to collect and derive multicast traffic statistics at each mesh node. To maintain backwards compatibility, multicast traffic without the eMFC-specific header is also honored by the MFC. Mobile mesh network specific interfaces, such as radio interfaces, as well as conventional interface types are supported. Security is maintained through the use of authentication and encryption techniques.

This application claims priority from U.S. Provisional Application Ser. No. 60/543,353, filed Feb. 9, 2004.

### BACKGROUND

Computers in the modern Internet communicate using a common language based on the well-understood mechanisms of routing. Routers in the Internet compute the best path to all known computers and act as traffic cops to direct such traffic. The results of these computations are stored in what is known as a forwarding table. This forwarding table specifies a next hop for each possible destination. The next hop is the computer to which traffic must be forwarded for a particular destination address.

Frequently a default router is specified as the preferred router to which to forward traffic when the destination is not known to a router. Non-router computers, known as hosts, also have a forwarding table. In the conventional Internet, a host's forwarding table tends to be much simpler than a router's forwarding table because hosts typically are connected to the Internet by one interface and the specified default router handles most addresses. These assumptions do not hold for hosts in a mobile mesh network. FIGS. 1 and 2 show a network topology where a node A provides unicast forwarding. Table 1 shows a unicast forwarding table for the 4-node network topology shown in FIGS. 1 and 2.

TABLE 1
Node A's unicast forwarding table

| Destination | Next Hop |
|---|---|
| B | B |
| C | C |
| D | D |

Internet addresses are the 32-bit integer addresses specified in Internet Protocol version 4 (IPv4) or 128-bit address specified in Internet Protocol version 6 (IPv6). Human readable addresses such as www.packethop.com are translated by Directory Name Servers (DNS) into their integer equivalents. These addresses are commonly known as unicast addresses. Unicast addresses specify a unique computer on the Internet. A portion of Internet addresses, however, are reserved for multicast.

Multicast addresses are used for 1-to-many communication from a computer to a group of computers. Traffic sent to a multicast address will arrive not at one computer, but will arrive at many computers. Examples of applications that might use multicast include classroom lectures and video conferences.

Routers that receive multicast traffic need to simultaneously forward that multicast traffic to one or more destinations. To do so, routers need to use a specific version of the forwarding table commonly known as the Multicast Forwarding Cache (MFC). Example operations for a multicast forwarding cache are shown in FIG. 3. A multicast group consisting of nodes B, C, and D are denoted by a single multicast address G. Table 2 shows node A's multicast forwarding cache and Table 3 shows node B's multicast forwarding cache.

TABLE 2
Node A's multicast forwarding cache

| Multicast Source | Multicast Receivers | Next Hops |
|---|---|---|
| A | G = {B, C, D} | B |

TABLE 3
Node B's multicast forwarding cache

| Multicast Source | Multicast Receivers | Next Hops |
|---|---|---|
| A | G = {B, C, D} | {C, D} |

To compute either the forwarding table or the multicast forwarding cache, a router first needs to compute paths to known destinations using a routing protocol. Several such routing protocols exist, all of which are based on well known graph theory algorithms established by mathematicians following on Euler's original work on the Königsberg Bridge problem in 1736.

These routing algorithms may be broadly categorized into link-state and distance-vector algorithms. Distance-vector algorithms exchange shortest-path distances to destinations between communicating routers. Based on this shortest-path distance information, each router independently computes its forwarding table. The prime example of a distance-vector based routing algorithm is the Routing Information Protocol (RIP). A link-state routing protocol, by contrast, distributes the topology of the network to all nodes, each of which independently computes its forwarding table. The prime example of a link-state algorithm is Open Shortest Path First (OSPF). Link-state based routing protocols are the most widely deployed in the Internet.

Once the routing protocol has computed the shortest path to all destinations, the router may update its forwarding table. These updates usually take place each time the network topology changes in a way that results in a forwarding table change. In a similar fashion, the router must update the multicast forwarding cache based on available information about multicast sources and receivers. To update the multicast forwarding cache, the router uses a multicast routing protocol. A multicast routing protocol may or may not use the previously computed unicast routing table. For example, the Protocol Independent Multicast (PIM) Protocol uses the results computed by the unicast routing protocol while the Distance Vector Distance Multicast Routing Protocol (DVMRP) uses its own internal unicast routing protocol. In either case, the multicast routing protocol updates the multicast forwarding cache on each router.

Internet hosts that are multicast receivers identify themselves to nearby routers using the Internet Group Management Protocol (IGMP). Each router then distributes this multicast group receiver membership information to peer routers using its multicast routing protocol. Internet hosts that are multicast sources simply send multicast packets destined for the appropriate multicast group address to its nearby routers. Each router is then responsible for forwarding those multicast packets as dictated by its multicast forwarding cache.

Mobile mesh networks are also known as Mobile Ad-hoc Networks (MANET). Mobile mesh networks, for example, are used by emergency services personnel where the communication nodes are wireless devices that are constantly moving. The Internet Engineering Task Force (IETF) has started the MANET workgroup to address mobile mesh network routing challenges.

Four unicast routing protocols specific to mobile mesh networks, referred to as ad-hoc routing protocols, have come out of the IETF MANET working group: Topology Dissemination Based on Reverse-Path Forwarding (TBRPF), Link State Routing Protocol (OLSR), Ad hoc On-Demand Distance Vector Routing (AODV), and The Dynamic Source Routing Protocol for Mobile Ad Hoc Networks (DSR). Three of these protocols have advanced to experimental Request For Comment (RFC) status (RFCs 3684, 3626, and 3561 respectively). The fourth ad-hoc protocol, DSR, is expected to advance to experimental RFC shortly. Multicast ad-hoc protocols have not yet been standardized.

Mesh Multicast Forwarding Caches

Mobile mesh networks differ from conventional Internet networks in a number of ways. The differences of most relevance to the multicast forwarding cache are mobility, lack of distinction between hosts and routers, Quality of Service (QoS) requirements, and security requirements.

A computer in a mobile mesh network, referred to as a node, may be constantly changing its position and connection to peer nodes. Unlike computers in more conventional wired computer networks, a mesh node may have continuously changing attributes such as location, IP address, and connection to peers. This breaks many of the assumptions built into conventional Internet protocols and networks.

A second consequence of mesh node mobility is commonly referred to as the “hidden node problem” as shown in FIG. 4. The hidden node problem refers to the inability of all mesh nodes to hear each other's traffic through the same wireless interface. This contrasts with the ability of wired interfaces to hear all traffic from connected neighbors. Conventional multicast forward caches do not support either changing IP addresses or interfaces suffering from the hidden node problem. For example, in FIG. 4, node C does not hear node A's transmissions and thus node C's scheduling of transmissions may interfere with node B's intended reception from node A. In this sense, node C is hidden from node A and vice versa.

In the conventional Internet, a computer may be viewed as a router or host depending on its relative position with the topology. Routers forward traffic on for peers, hosts do not. Typical computer users rarely, if ever, use a router. This is reflected in many design assumptions applied to computers used most often by users such as laptops, Personal Digital Assistants (PDAs) and personal computers. For example, a multicast forwarding cache is not typically available in end-user platforms such as Windows XP and CE operating systems. In a mobile mesh network, however, every node is by definition a router and may also be a host. That is to say, each node must be capable of forwarding traffic on for peers. This blurs the distinction between host and router for mesh nodes.

Mobile mesh network wireless interfaces have stronger hurdles than wired interface equivalents in terms of Quality of Service (QoS). As a consequence, QoS continues to be important in parts of the Internet like mobile mesh networks. Conventional multicast forwarding caches however have little or no support for QoS. Wireless mobile mesh network traffic is also more susceptible to interception than conventional wired networks. Because of the ease of interception, mobile mesh network traffic must be more carefully guarded, even at the transport level.

For these four reasons, conventional multicast forwarding cache technology fails to meet the needs of mobile mesh network nodes. This invention addresses this and other such problems.

### SUMMARY OF THE INVENTION

An Enhanced Multicast Forwarding Cache (eMFC) supports multicast transmissions in mobile mesh networks. The enhanced MFC is designed to support mesh node mobility, quality of service, and security requirements that are particular to mesh networks. To achieve these goals, the enhanced MFC draws from a global state maintained by a unicast routing protocol, multicast aware applications, and distributed services. The eMFC distributes this derived global state through the use of an eMFC-specific multicast packet header. Information contained within the eMFC header is also used to collect and derive multicast traffic statistics at each mesh node. To maintain backwards compatibility, multicast traffic without the eMFC-specific header is also honored by the MFC. Mobile mesh network specific interfaces, such as radio interfaces, as well as conventional interface types are supported. Security is maintained through the use of authentication and encryption techniques.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 shows a conventional network topology.

FIG. 2 shows unicast paths for a node in the conventional network shown in FIG. 1.

FIG. 3 shows a multicast path for multicast source A and destinations B,C, and D.

FIG. 4 shows three mesh nodes illustrating a hidden node problem.

FIG. 5 shows an enhanced MFC system architecture.

FIG. 6 shows a multicast packet that includes an enhanced MFC (eMFC) packet header.

FIG. 7 shows how the multicast packet in FIG. 6 is sent between different nodes in a mesh network.

FIG. 8 is a table that shows the different fields in the eMFC header.

FIG. 9 is block diagram showing how the multicast packets can be overlayed with different mesh networks.

FIGS. 10-12 are diagrams showing how a mesh node forwards multicast packets according to mesh interface information.

FIGS. 13-15 are diagrams showing how duplicate multicast packets are handled in a mesh network.

FIG. 16 is a diagram showing a malicious listener within radio range of mesh nodes.

FIGS. 17-19 show how Quality of Service (QoS) operations are performed using eMFC.

FIG. 20 is a block diagram of the components in one of the mesh nodes.

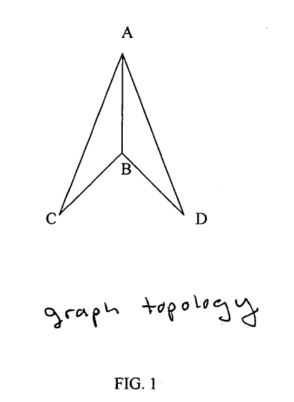

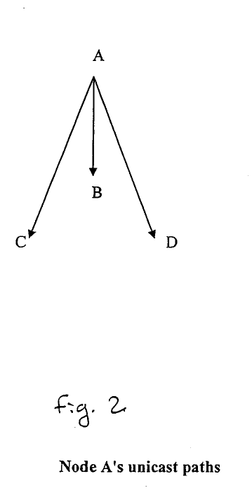

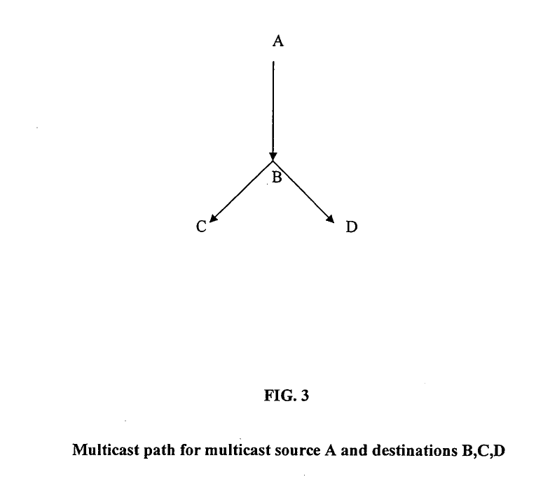

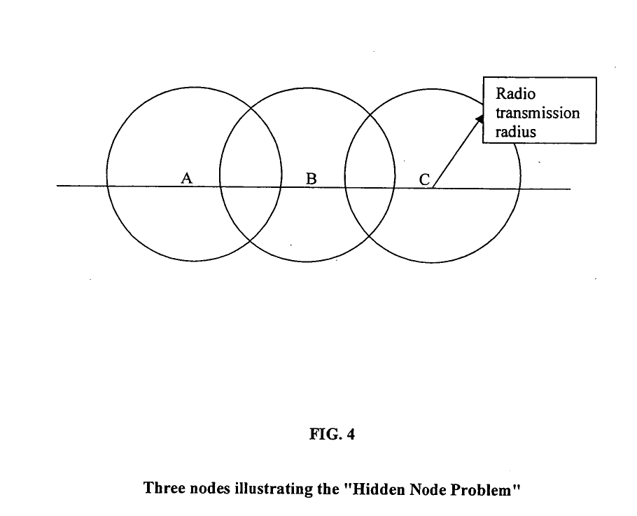

### DETAILED DESCRIPTION

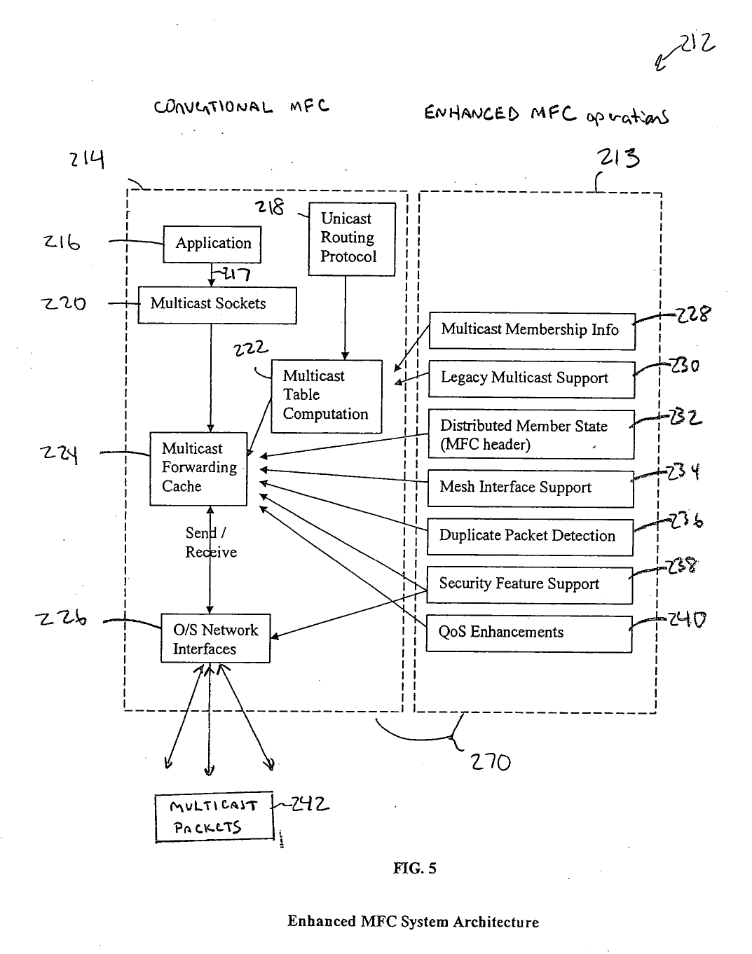

Referring to FIG. 5, an Enhanced MFC (eMFC) system architecture 212 is a distributed multicast routing mechanism and consists of a multicast forwarding cache 224 and a multicast table computation 222. These two components derive information from global and local states available on a mesh node to properly route multicast traffic. All of the nodes running the enhanced MFC 212 create an overlay network over both mobile mesh networks and conventional Internet Protocol (IP) based networks.

FIG. 5 shows a node 270 that operates the enhanced MFC 212 in a mesh network. Multicast aware applications 216 use socket application program interface (API) calls 217 to open a multicast socket 220, declare itself as a multicast source, set the multicast data type (e.g. video, voice, bulk data, and so forth), send multicast data 242, receive multicast data 242, and close the socket 220. These socket calls 217 rely on the underlying multicast forwarding cache 224 to select the zero or more network interfaces 226 for forwarding multicast traffic 242.

The multicast forwarding cache 224 is maintained by a multicast table computation component 222. Multicast table 222 fills in the multicast forwarding cache 224 with entries for each known multicast source and group. The multicast table computation component 222 derives these multicast group senders and groups from global state information available within the mobile mesh network. A public example of such a global state distribution protocol is the Multicast Session Directory sdr modeled on work done by Van Jacobson at Lawrence Berkeley National Laboratory (LBNL).

The multicast table computation component 222 derives a network topology from the underlying unicast routing protocol 218. Ideally, protocol 218 is a proactive, ad-hoc, link-state based protocol, however it need not be. Internet multicast protocols Distance Vector Multicast Routing Protocol (DVMRP) and Multicast Extensions to OSPF (Open Shortest Path First), for example, derive their topology information from distance vector and link-state protocols respectively. The conventional elements in block 214 are well known to those skilled in the art and are therefore not described in further detail.

Enhanced multicast operations are shown in block 213. Multicast membership information 228 and legacy multicast support 230 are provided to the multicast table computation 222. The multicast membership information 228 in one example is global state information that all mesh nodes contain that is distributed using a Distributed Distribution Service (DDS) as described in co-pending application entitled: RELIABLE MESSAGE DISTRIBUTION IN AN AD HOC MESH NETWORK, Ser. No. ______, which is herein incorporated by reference. Legacy multicast support 230 relates to existing multicast support in either the MFC 224 or in the multicast packet. If a node does not include an eMFC header, then the packet can revert back to using legacy multicast support 230 from a conventional multicast packet. Mesh interface support 234 relates to specific mesh node information. For example, a node may determine that a particular interface is a mesh interface and accordingly provide any necessary routing decision to account for the mesh network.

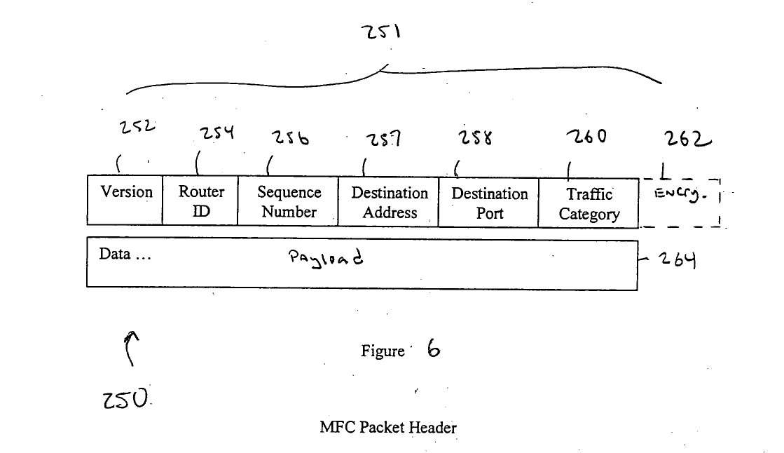

The enhanced MFC 212 is provided through a distributed member state 232 that is relayed to the nodes in the mesh network through an enhanced MFC header 250 that is shown in more detail in FIG. 6.

Three eMFC operations of particular interest include duplicate packet detection 236, security feature support 238 and QoS enhancements 240.

Distributed Multicast State

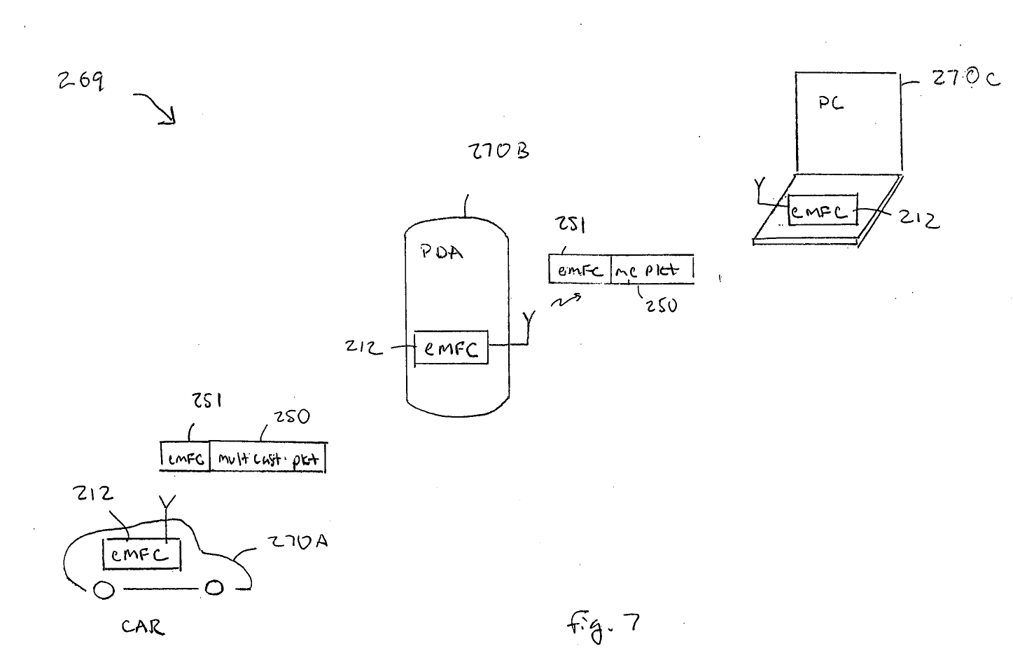

Referring to FIGS. 6 and 7, the enhanced MFC 212 is a distributed multicast routing mechanism that maintains global state using proprietary packet header 251 pre-pended on multicast packets 250. This distributed state is necessary for proper support of features such as Quality of Service and link quality measures. As each multicast packet 250 flows through the enhanced MFC 212 (FIG. 5) operating on a mesh node, it is marked by pre-pending the eMFC specific header 251. This header 251 contains fields necessary to distribute eMFC state to peer mesh nodes 270 and support features such as Quality of Service (QoS).

As the multicast packet 250 flows across a mobile mesh network 269 (FIG. 7), this same eMFC header 251 is seen by each enhanced MFC 212 along the path to the final multicast destinations. This is because each mesh node 250 consults the eMFC 212 before forwarding the multicast packet 250.

For example, in FIG. 7, a first mesh node 270A may be located in a vehicle, a second mesh node 270B may operate in a Personal Digital Assistant (PDA), and a third mesh node 270C may operate in a wireless laptop computer. The multicast packet 250 is sent by node 270A and is prepended with the eMFC header 251. The eMFC 212 in mesh node 270B routes the multicast packet 250 to mesh node 270C according to the information in the eMFC header 251. Mesh node 270C receives and possibly continues to route the multicast packet 250 according to the information in eMFC header 251. As the multicast packet 250 flows through the mesh network 269, moving from one mobile mesh network node 270 to another, the enhanced MFC packet header 251 serves to distribute state for this multicast stream to all mesh nodes along its path.

The MFC packet header 251 allows the mesh nodes to conduct more effective multicast related operations such as duplicate packet detection 236, security feature support 238, and QoS enhancements 240 (FIG. 5) that are not currently supported in conventional mesh networks.

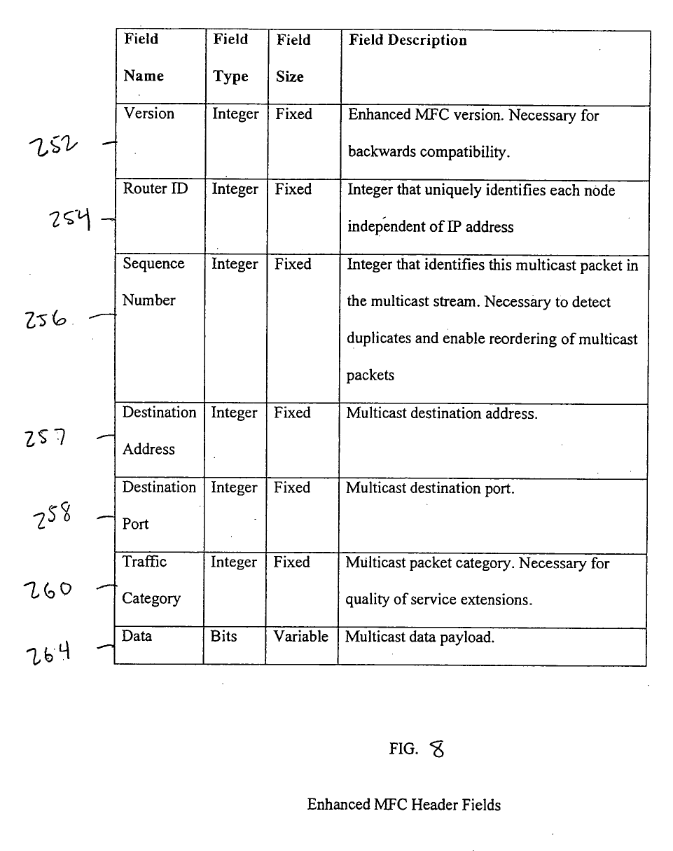

The individual fields of the eMFC header 251 are described in further detail in FIG. 8. A version number 252 is used for backwards compatibility with other multicast versions. Mesh nodes sending multicast packets 250 are identified with a Router Identifier (Router ID) 254 to eliminate dependence on IP addresses that may or may not change over time as the node 270 moves and turns interfaces on and off. The router ID 254 remains constant throughout the lifetime of the mobile mesh network, is associated with a particular mesh node, and is not tied to any IP source address. Thus the router identifier 254 can remain the same for a mesh node 270 even when the node moves to another location in the same or a different mesh network.

The header 251 includes a sequence number 256 that identifies the multicast packet number in the multi-cast stream sent by a particular router ID 254. A destination address 257 and destination port 258 identify the multicast address for a particular multicast group such as shown in tables 2 and 3 above. The traffic category 260 is used for QoS operations in the mesh nodes 270. In addition to distributing state, the eMFC header 251 can also be used in the nodes to derive multicast traffic statistics. These statistics can be used for quality of service features described below. An optional encryption value 262 shown in FIG. 6 can be used for identifying a type of encryption scheme used with the multicast packet 250. In one implementation, the eMCF header 251 is located after the IP header and before the data payload 264.

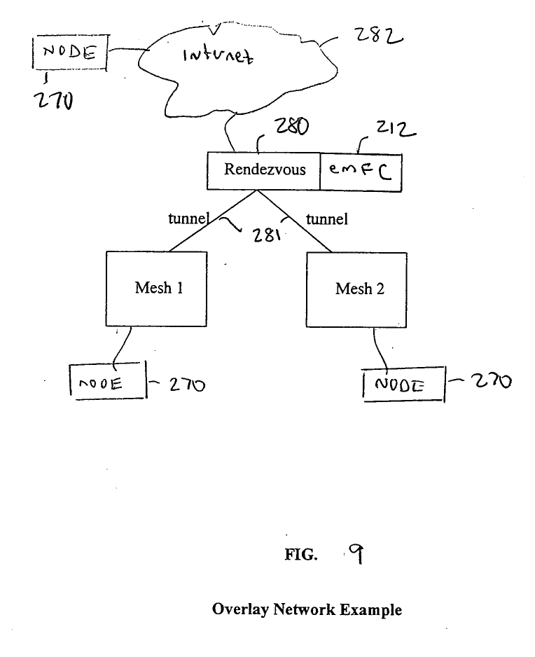

FIG. 9 shows how nodes within the mobile mesh network are either directly connected to other nodes in the same mesh or with other mobile mesh networks via an overlay network. For example, two meshes named mesh 1 and mesh 2 communicate between themselves via a rendezvous 280. The rendezvous is a publicly know, pre-established server that connects to meshes 1 and 2 via a tunnel 281.

The rendezvous server 280 itself contains an enhanced MFC 212 and appears as a mesh node peer to mesh nodes 1 and 2. The nodes on mesh 1 and mesh 2 can communicate with each other using eMFC 212 or can communicate with other nodes in Internet 282 via conventional multicast protocols. Thus two nodes on disparate mesh networks or on different mesh and Internet networks can exchange the eMFC information contained in the eMFC header 251 (FIG. 6).

Mesh Interface Support

Enhanced MFC 212 supports multicast on both conventional Internet network interfaces and mesh-specific network interfaces. Specifically, the eMFC 212 supports interfaces that suffer from the hidden node problem by repeating multicast traffic on those mesh node interfaces that face multicast listeners that may not normally hear multicast traffic.

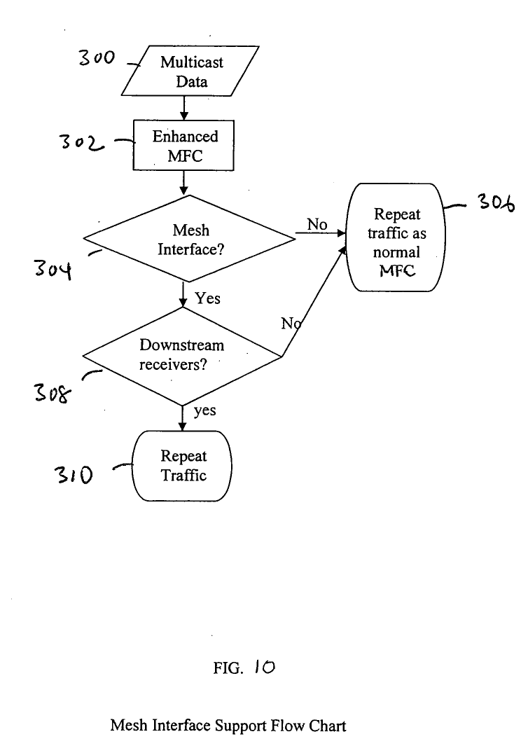

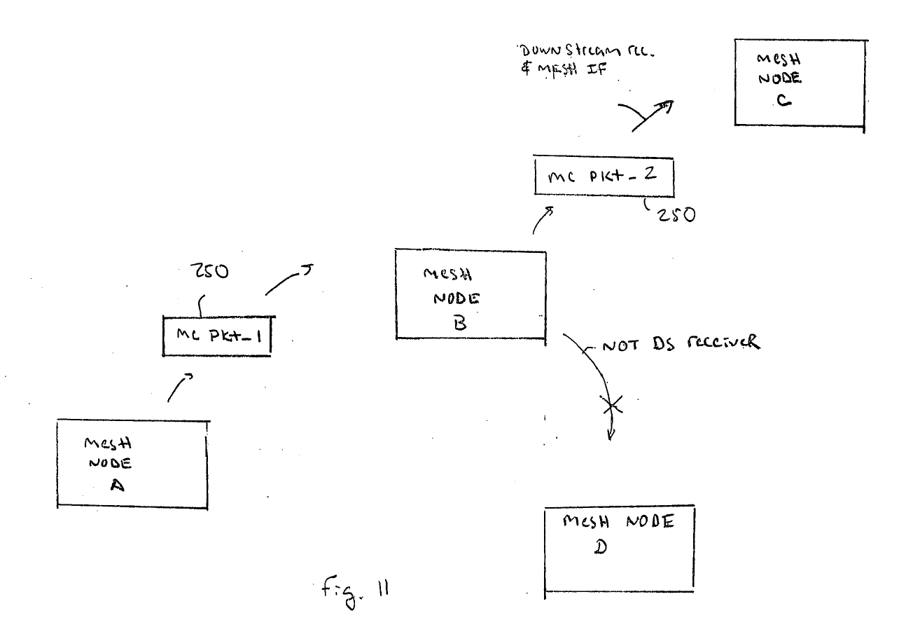

Referring to FIGS. 10 and 11, a multicast packet 250 sent from a conventional interface may be expected to reach all peers connected to that interface. Ethernet interfaces on a hub or switch are examples of conventional interfaces. Even if this assumption is not true, for example in the case of multicast transmissions passing through some switches, the underlying system components, in this case the switch, have been designed to compensate.

In the case of mesh interfaces, however, no such compensation exists. Instead mesh nodes must repeat multicast traffic on some mesh interfaces for the benefit of downstream nodes that can not hear the original multicast transmission. For example, in FIG. 11, mesh node A may send out a multicast packet 250 that is destined for node C. However, node C may not be in range to receive packet 250 directly from node A. In this situation, node B has to operate as a router to relay multicast packet 250 from node A to node C. However, blindly repeating multicast packet 250 to every node within range can create broadcast storms where all nodes are broadcasting the same multicast packets.

To eliminate this and other problems, the mesh nodes take into account mesh interface information when making decisions regarding forwarding multicast packets. For example, in FIG. 10, node B (FIG. 11) may receive a multicast packet in block 300. Node B determines that the packet 250 has an enhanced MFC header 251 in block 302. Node B in decision block 304 determines whether or not the packet must be repeated on the received mesh interface. If not, then any conventional multicast routing is performed in block 306. However, if the packet must be repeated on the received mesh interface in decision block 304, then the node determines if it has any downstream receivers associated with the mesh interface in decision block 308. If not, then the multicast packet need not be repeated and normal multicast operations are conducted in block 306. If node B does have downstream receivers in decision block 308, the multicast packet is repeated to the identified downstream nodes in block 310 on the received mesh interface, thus forwarding traffic onwards to downstream nodes that can hear the received mesh interface but not the original multicast packet (FIG. 11).

Downstream nodes may or may not be members of the multicast group associated with the multicast address in the eMFC header 251 (FIG. 6). For example in FIG. 11, the multicast packet 250 is sent to mesh node B from node A. Even though node C may not be identified in the multicast group for multicast packet 250, node B may still forward the packet to node C since node C is a downstream receiver for node B. This allows another mesh node downstream from node C, that is a member of the multicast group, to successfully receive multicast packet 250 from node C. In this example, node D is not a designated downstream mesh node for node B. Thus, node C will not transmit multicast packet 250 to mesh node D. This prevents the broadcasting storms that normally occur when multicast packets are sent over a mesh network.

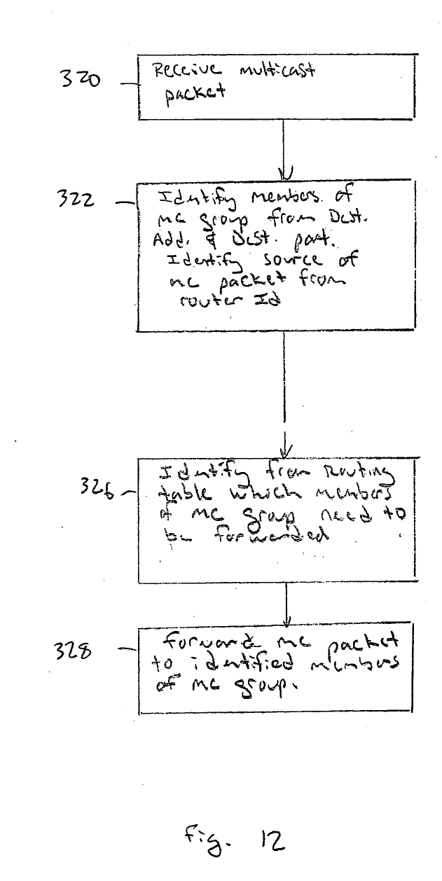

FIG. 12 shows in more detail how node B routes multicast packets 250. Node B receives the multicast packet in block 320. Node B identifies the members of the multicast group in block 322 according to router ID 254, the destination address 257 and destination port 258 (FIG. 6) in the eMFC header 251 and the distributed multicast routing table. The source of the multicast packet is identified in block 322 via the router identifier 254 in the eMFC header 251.

In block 326 node B (FIG. 11) identifies any nodes for forwarding the multicast packet 250 according to local routing tables. In other words, the multicast routing table in block 326 may require node B to forward the multicast packet from the source node identified in block 322 to one or more of the nodes identified in block 322. Accordingly, node B forwards the multicast packet 250 to the identified nodes in block 328, if they pass the mesh interface criteria described in FIG. 10.

Conventional routing protocols notify nodes of their associated downstream nodes. This for example, is performed by the multicast membership information 228 in FIG. 5. The distributed eMFC headers 251 then identify the particular multicast group associated with the multicast packet 250.

Duplicate Packet Detection

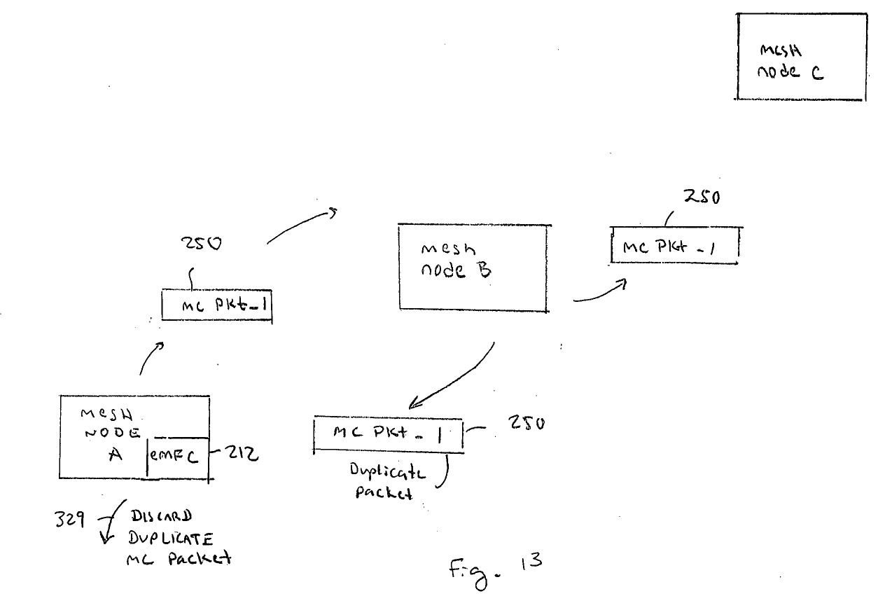

Nodes in the mesh network have the possible disadvantage of receiving duplicate multicast packets. A mesh node may receive multiple copies of the same multicast traffic for a variety of reasons including mobility or interface changes. For example, in FIG. 13 a node A may send out a multicast packet 250 to node B. Node B may then broadcast the same multicast packet 250 to node C. However, that same broadcast of multicast packet 250 may also be received back at node A. The duplicate multicast packet 250 can cause node A to repeat processing on the same multicast packet. Thus, duplicate packet detection is particularly important in the mobile, wireless environment of a mobile mesh network. The duplicate packets 250 are identified by the eMFC 212 in node A and silently dropped in operation 346 before reaching the application that processes the packet.

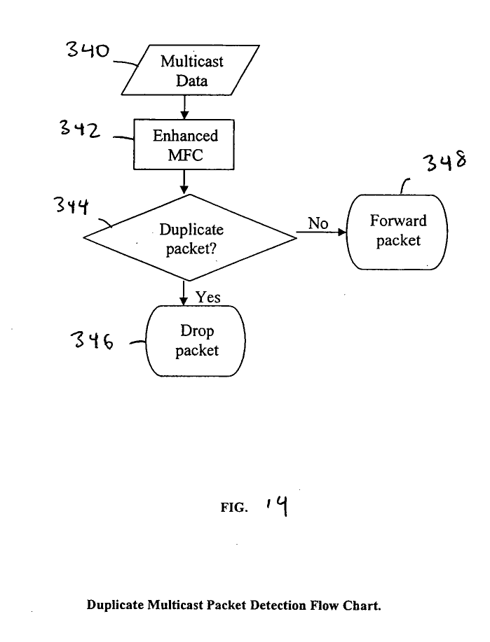

FIG. 14 shows the basic logic performed at the eMFC 212 to detect and drop duplicate packets. In block 340, the node receives a multicast packet. In block 342 the enhanced MFC 212 in the node reads the information in the eMFC header 251 (FIG. 6). If the eMFC information 251 indicates a received multicast packet is a duplicate of a packet previously received by the same node, the packet is dropped in block 346. If not, the packet is forwarded in block 348.

Duplicate multicast packets are detected using a combination of the router ID 254, sequence number 256, destination address 257 and destination port 258 in the eMFC header 251 (FIG. 6). This provides more exact determination of duplicate packet reception.

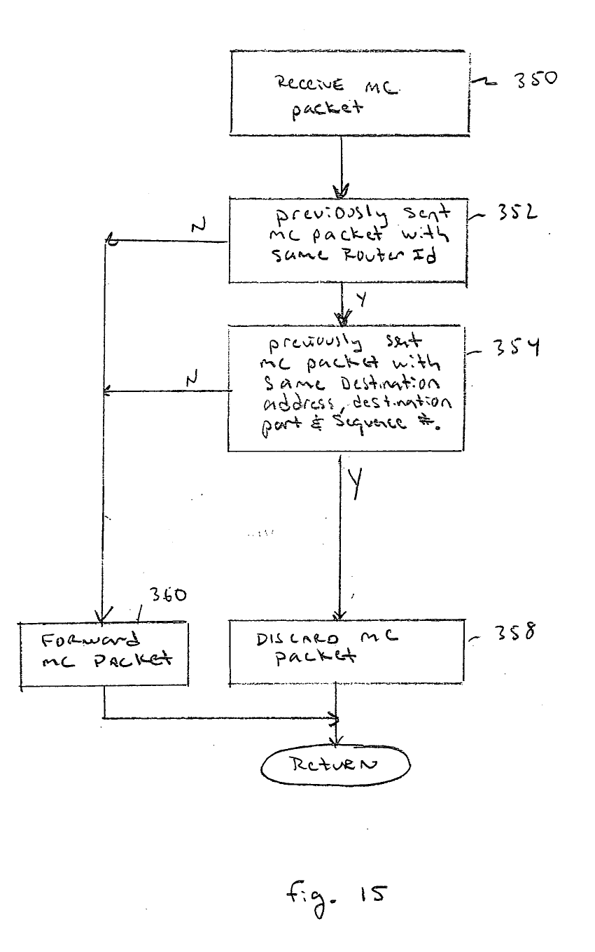

FIG. 15 explains in more detail. In block 350 a mesh node receives a multicast packet. The eMFC 212 checks the router ID 254 in the packet header 251 (FIG. 6). If packets with the same router ID have never been processed, the node forwards the multicast packet in a normal manner in block 360. If the node has received other packets with the same router ID in block 352, then the destination address 257, destination port 258, and packet sequence number 256 values are checked in block 354. If these values are different than other recently transmitted packets, the packet is forwarded in block 360. If the router ID, destination addresses, and sequence number are the same as another packet flows recently transmitted in block 360, the packet is determined to be a duplicate and discarded in block 358.

The enhanced MFC 212 tags each multicast packet at the source node with a monotonically increasing sequence number 256. The sequence number 256 is accordingly used at each hop in the path from source to receivers to weed out and drop duplicate multicast packets. Note that multicast packets may arrive out of order, so the eMFC 212 checks for reception of multicast sequence numbers rather than simply keeping a maximum sequence number for each multicast stream. Likewise sequence numbers may “roll-over”. A sequence number rolls-over when the maximum sequence number has been assigned and the next packet is marked with the lowest sequence number. The eMFC 212 also compensates for sequence number roll-over.

Security Feature Support

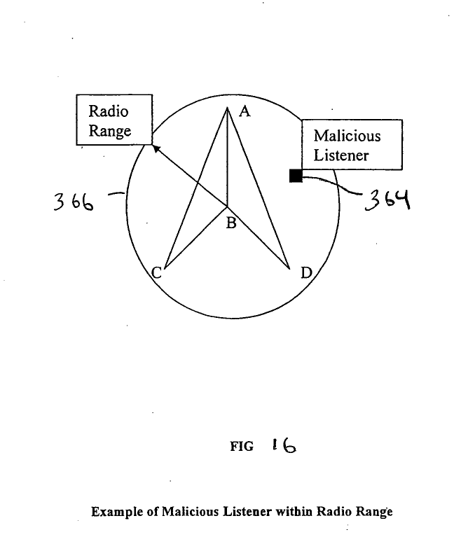

In FIG. 16, multicast traffic between nodes running the enhanced MFC 212 is secured by supporting security features such as authenticating adjacent neighbors and encrypting multicast traffic hop-by-hop. Security is particularly important in a frequently changing, mobile wireless network, such as mobile mesh network. Each mobile node A-D using the eMFC 212 may take advantage of security features available in the system. For example, each mobile mesh node A-D authenticates itself to directly connected neighbors.

After authenticating each other and exchanging certificates, mobile node peers then encrypt multicast traffic on a hop-by-hop basis. Thus multicast traffic destined for a mobile node peer that mistakenly arrives at a listener within radio range 366 does not arrive in the clear. A malicious listener 364 must first break the encrypted multicast packet as sent by the previous hop. This encryption is carried out across tunnels established between mesh nodes A-D and the rendezvous 280 (FIG. 9) as well.

In addition, an encryption identifier 262 may optionally be contained in the eMFC header 251 to identify a particular type of encryption scheme used by the source of the multicast packet 250.

QoS Enhancements

Enforcement of Quality of Service (QoS) is particularly important in a wireless environment with limited bandwidth and potential radio interference such as in mobile mesh networks. The enhanced MFC 212 supports quality service through traffic measurement and enforcement measures such as packet prioritization, admission control, and traffic shaping. Applications aware of the eMFC 212 support these QoS features by marking application packets into well known categories. Legacy application packets are marked as “best effort” by default.

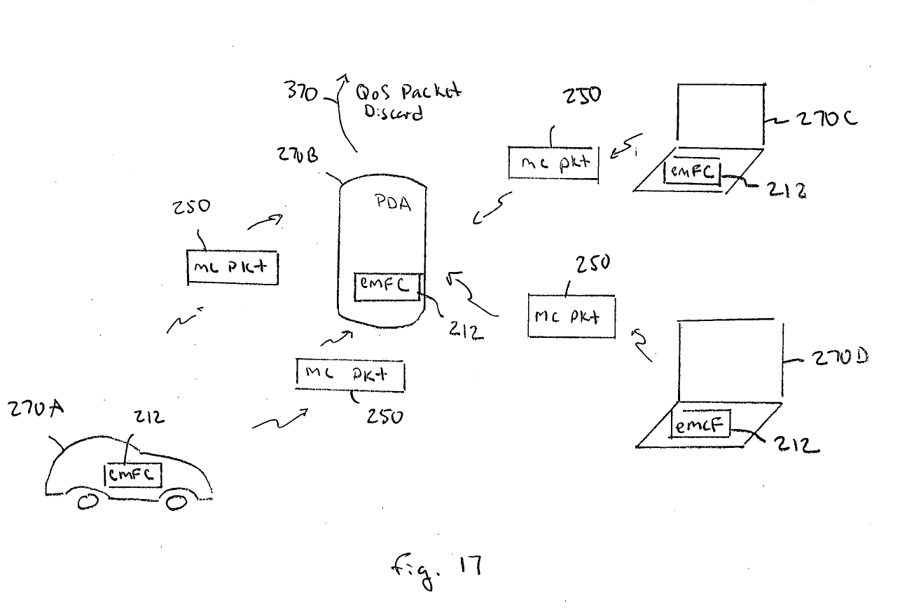

To explain further, FIG. 17 shows multiple mesh nodes 270 that each may transmit and receive multicast packets 250. One or more of the mesh nodes may make QoS decisions regarding received packets. For example, a node 270A may be located in a vehicle that sends multicast packets 250 to a PDA node 270B. At the same time, PC mesh nodes 270C and 270D may also send multicast packets 250 to the PDA node 270B. Unfortunately, the PDA node 270B may not have the capacity to process and forward all of the multicast packets received from nodes 270A, 270C and 270D. In this case, some of the packets 250 may have to be dropped in QoS operation 370. Alternatively, the PDA node 270B may be able to process some or all of the received packets 250, but must prioritize their processing order.

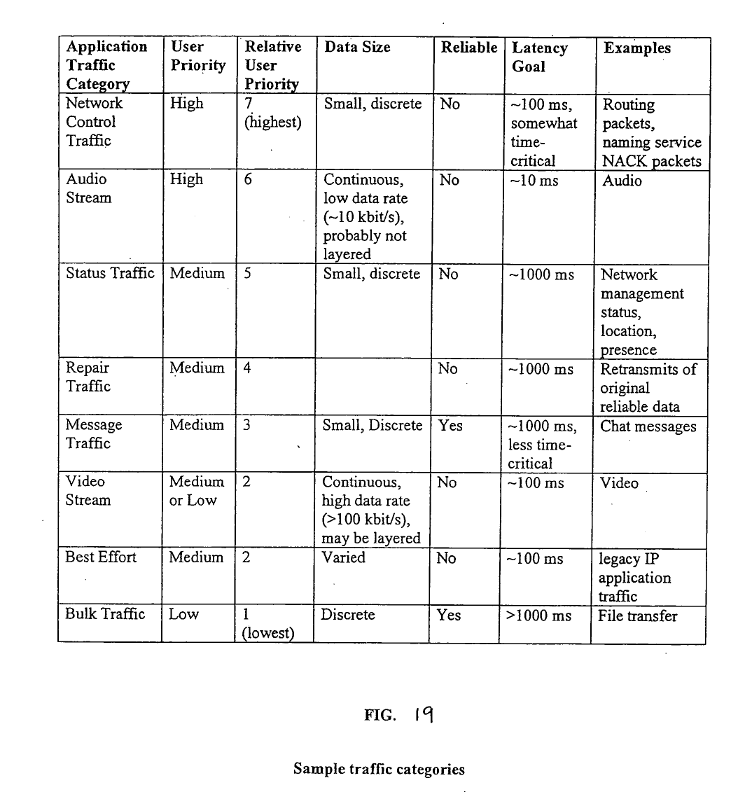

Multicast packets handled by the eMFC 212 are prioritized according to their traffic category 260 (FIG. 6). Sample traffic categories are shown in the priority table in FIG. 19. If an eMFC transmission queue becomes too full, packets are dropped using drop priorities specified by the traffic categories 260. For example, all video packets that make up a video frame may be dropped at once rather than simply dropping individual video packets. The eMFC 212 can also mark multicast packets with the appropriate differentiated services field codepoints (DSCP) bits as defined by the IETF. This permits further prioritization below the eMFC 212 by interfaces that support traffic prioritization such as 802.11i interfaces.

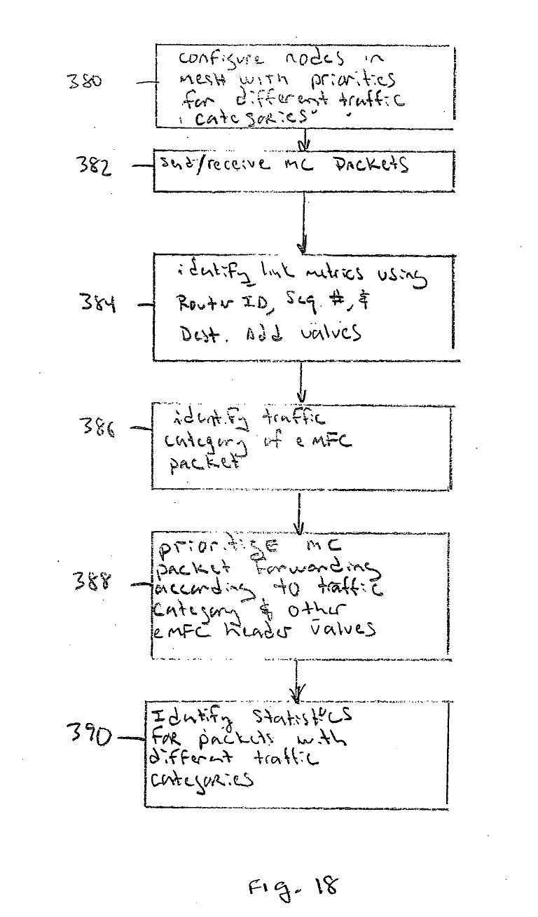

FIG. 18 describes in more detail how the enhanced MFC 212 in the nodes 270 in FIG. 17 are used for conducting QoS services. In block 380, the nodes 270 are configured with a priority table for different traffic categories. One example of a priority table is shown in FIG. 19 and may be distributed to the different nodes 270 using the DDS system described in co-pending patent application entitled: entitled: RELIABLE MESSAGE DISTRIBUTION IN AN AD HOC MESH NETWORK, Ser. No. ______ which was referred to above.

As the enhanced MFC 212 sends and receives multicast traffic from peers in block 382, it also measures link quality hop-by-hop with respect to multicast traffic. It does so by tracking the number of multicast packets sent and received successfully for each directly connected peer mesh node running the eMFC 212. These measurements are taken in block 384 according to different combinations of the router ID 254, destination address 256, destination port 258, sequence number 256, and traffic category 260 in the eMFC header 251 (FIG. 6). Link costs, as computed by the multicast table computation component 222 (FIG. 5), are a combination of link capacity, link quality, and the node's willingness to serve as a router averaged over time.

The final metric is a combination of these factors as well as platform characteristics such as CPU speed, total memory, and battery capacity. As link quality changes, link costs reflect the changes and the multicast table computation component prefers those links with better metrics when computing multicast forwarding cache entries.

Given individual link metrics, traffic category distributions, and maximum link capacity derived in block 384, the eMFC 212 can impose multicast rate limits if desired. Policy set by network administration on traffic limits for multicast packets will be enforced by the eMFC 212. For example, a service level agreement (SLA) concerning the amount of video traffic permissible in the mobile mesh network can be enforced to limit the video traffic allowed at each hop during multicast transmission. Video sources that exceed this limit would not be allowed past the first eMFC 212, sparing the mobile mesh network from excessive traffic.

For example, the eMFC 212 in block 386 identifies video traffic in block 386 via the traffic category 260 in FIG. 6. The eMFC 212 identifies the source of the video traffic and the amount of video traffic received from that source in block 384 according to the router ID 254 and corresponding sequence number 256. The eMFC 212 then prioritizes the processing of the video traffic in block 388 according to the priority table shown in FIG. 19. As shown in the priority table of FIG. 19, highest priority may be given to different types of low bandwidth control traffic. The larger data traffic, such as video data may be given a lower priory. The eMFC 212 may then either drop or delay the processing of some or all of the video traffic according to the amount of received traffic.

In another implementation, the multicast groups identified by the destination address 257 and the destination port 258 may have different priority levels. This allows messages from particular users, such as supervisors or emergency personnel to send messages at a higher priority than other users. Thus, the combination of the router ID 254, destination address 257, destination port 258 and traffic category 260 is used to assign particular groups of users different priority levels.

The eMFC 212 can enforce multicast session characteristics such as the number of multicast sessions, throughput per session, or multicast participants per session. In block 390 the eMFC 212 can then track the statistics for particular types of data such as packets received from a particular source (router ID), destination address and/or port, or packets having a particular traffic category. The statistics can identify the amount of packets received for the particular type of traffic and the percentage of that type of traffic that was successfully processed, dropped, etc.

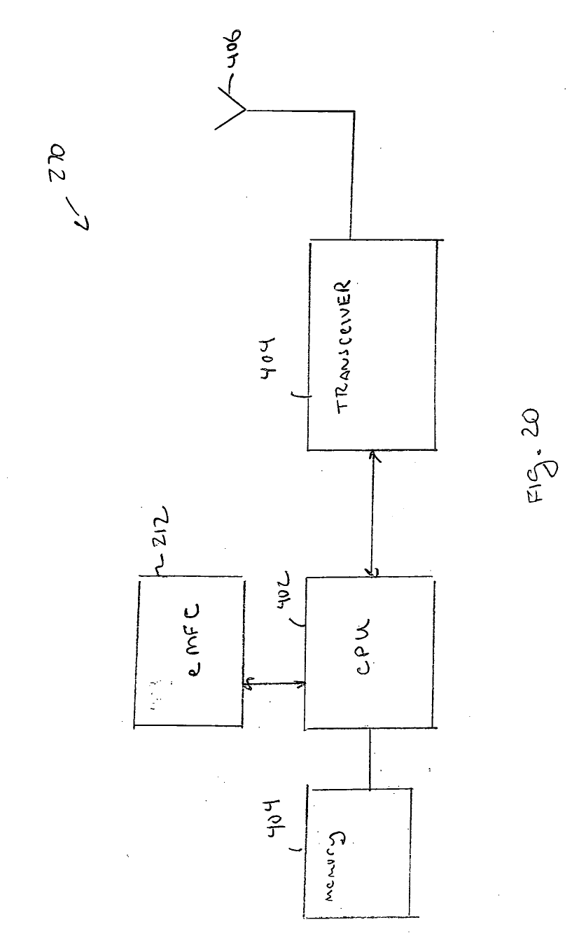

FIG. 20 shows the components inside a mesh node 270 used for conducting eMFC 212. A Central Processing Unit (CPU) 402 accesses software that provides the eMFC operations 212. The CPU 402 sends and receives multicast packets via a transceiver 404 and antenna 406. A memory 402 may include the multicast routing tables and priority tables described above.

Legacy Multicast Support

The enhanced MFC 212 supports multicast traffic generated both with and without eMFC headers 251. Thus the eMFC supports both legacy multicast applications and those written using eMFC features. Not all multicast applications will take advantage of the features of the eMFC 212. Consequently, support for legacy multicast applications is built in to the eMFC. Using this legacy source and receiver information, the eMFC 212 sets the multicast forwarding cache 224 (FIG. 5) and forwards multicast packets from multicast source applications according to the eMFC 212. Legacy multicast packets received without the eMFC headers 251 are passed directly to the applications registered for that multicast group.

Legacy multicast applications running on mesh nodes hosting an eMFC 212 use standard multicast socket API calls 217 (FIG. 5). These calls are intercepted, noted, and passed along by the eMFC 212. Legacy multicast sources running on nodes in the mobile mesh network that do not host the eMFC 212 are detected by neighbor nodes running the eMFC 212. An example of such a multicast source would be a camera within the mesh sending video multicast traffic. Multicast receivers running on nodes in the mobile mesh network not running the eMFC 212 are detected via the IGMP messages issued by every multicast receiver. Legacy multicast sender and receiver information is propagated as global state. Legacy multicast packets are marked for “best effort” delivery, the default quality of service class.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I claim all modifications and variation coming within the spirit and scope of the following claims.

1. A node operating in a mesh network, comprising:
a processor operating an enhanced multicast forwarding protocol that provides a Multicast Forwarding Header (MFH) for multicast packets transmitted over the mesh network, the MFH including a device identifier for a sending node and being independent of any Internet Protocol (IP) address associated with the sending node and further including a multicast group identifier identifying nodes in the mesh network associated with a same multicast group.

2. The node according to claim 1 wherein the processor:
uses the multicast group identifier to identify multicast groups for the received packets;
uses the identified multicast groups and the source identifier to identify which nodes in the identified multicast groups need to be forwarded the received multicast packets; and
forwards the multicast packets to the identified nodes.

3. The node according to claim 1 including a sequence number in the MFH used by the processor in combination with the device identifier and the multicast group identifier to identify and drop duplicate multicast packets that have been transmitted by the processor and then received back from another node in the mesh network.

4. The node according to claim 1 wherein the processor identifies downstream nodes in the mesh network and sends the multicast packets to the identified downstream nodes even when the downstream nodes are not identified nodes in the multicast group.

5. The node according to claim 1 including a traffic category in the MFH that identifies different traffic categories for the multicast packets.

6. The node according to claim 5 including a priority table that is used in combination with the traffic category in the MFH to prioritize the processing of the multicast packets.

7. The node according to claim 6 wherein the processor prioritizes the multicast packets according to the traffic category, priority table, device identifier, multicast group identifier and a sequence number in the MFH.

8. The node according to claim 7 wherein the priority table and a multicast routing table used by the processor for prioritizing multicast packet processing are automatically distributed to the node.

9. The node according to claim 8 wherein the processor maintains packet processing metrics for the multicast packets according to the traffic category.

10. An ad-hoc mesh network, comprising:
multiple mobile nodes that conduct logical point-to-point wireless communications with their neighbors within the mesh network and further provide hops for forwarding messages between other nodes in the mesh network, the nodes providing a mesh multicast protocol that forwards multicast packets between different nodes according to both a mesh network routing table and a mesh based multicast header in the multicast packets.

11. The network according to claim 10 including a device identifier in the multicast header associated with a particular device sending the multicast packets that does not change when the device moves to different locations in and out of the mesh network.

12. The network according to claim 11 including a source router ID, multicast destination address and port address in the multicast header that identifies nodes in the mesh network that are members of a same multicast group.

13. The network according to claim 11 including a sequence number in the multicast header used in combination with the device identifier to identify duplicate multicast packets sent from and returned back to the same node.

14. The network according to claim 10 including a traffic category in the multicast header used by the nodes to prioritize the processing and forwarding of packets to other nodes in the mesh network.

15. The network according to claim 14 including a priority table and a multicast routing table that are automatically distributed to the different nodes in the mesh network that are used in combination with a device identifier, a sequence number, a multicast group address and the traffic category in the multicast header to prioritize the processing and forwarding of the multicast packets.

16. A method for distributing multicast packets in the ad-hoc mesh network, comprising:
using a Multicast Forwarding Cache (MFC) to identify mobile nodes in the mesh network that require forwarding of wirelessly received multicast packets;
receiving multicast packets that contain a multicast header that is adapted for multicast operations in the mesh network; and
using the MFC in combination with the multicast header to forward the multicast packets to other nodes in the mesh network.

17. The method according to claim 16 including selectively dropping received duplicate multicast packets according to a device identifier, sequence number, and multicast group identifier in the multicast header.

18. The method according to claim 17 including:
using the multicast header to identify a multicast group associated with a received multicast packet; and
repeating the multicast packet to any nodes in or out of the multicast group that are associated with a downstream mesh interface in the mesh network.

19. The method according to claim 16 including receiving multicast packets from nodes in the mesh network and prioritizing the processing and forwarding of the multicast packets according to a traffic category identified in the multicast header.

20. The method according to claim 19 including maintaining processing metrics on the multicast packets according to the identified traffic category.
